(19) United States
(12) Patent Application Publication
(10) Pub. No.: US 2015/0227170 A1
(43) Pub. Date: Aug. 13, 2015

(54) TOUCH SENSOR AND METHOD FOR MANUFACTURING THE SAME

(71) Applicant: SAMSUNG ELECTRO-MECHANICS CO., LTD., Gyeonggi-Do (KR)

(72) Inventors: Sung Ho KIM, Gyeonggi-Do (KR); Jae Hun KIM, Gyeonggi-Do (KR); Jin Uk LEE, Gyeonggi-Do (KR)

(73) Assignee: SAMSUNG ELECTRO-MECHANICS CO., LTD., Gyeonggi-Do (KR)

(21) Appl. No.: 14/602,875

(22) Filed: Jan. 22, 2015

(30) Foreign Application Priority Data
Feb. 13, 2014 (KR) 10-2014-0016763

(51) Int. Cl. G06F 1/16; G06F 3/041; B32B 37/24; G06F 3/044

(52) U.S. Cl. CPC G06F 1/1643; G06F 3/044; G06F 3/0412; B32B 37/24; G06F 2203/04103; B32B 2037/243; B32B 2457/208

(57) ABSTRACT

Embodiments of the invention provide a touch sensor, including a first window substrate, a dam formed along an edge of the first window substrate, and a polymer layer formed on the first window substrate in an inside direction of the dam. According to at least one embodiment, the touch sensor further includes a bezel formed to be disposed outside the dam and formed on the first window substrate, and a second window substrate having one surface formed to face the first window substrate and the other surface provided with an electrode pattern, and provided with an electrode wiring, which is electrically connected to the electrode pattern.

### CROSS REFERENCE TO RELATED APPLICATION

This application claims the benefit of and priority under 35 U.S.C. §119 to Korean Patent Application No. KR 10-2014-0016763, entitled “TOUCH SENSOR AND METHOD FOR MANUFACTURING THE SAME,” filed on Feb. 13, 2014, which is hereby incorporated by reference in its entirety into this application.

### BACKGROUND

1. Field of the Invention:

The present invention relates to a touch sensor and a method for manufacturing the same.

2. Description of the Related Art:

With the development of computers using a digital technology, computer-aided devices have also been developed, and personal computers, portable transmitters and other personal information processors execute processing of texts and graphics using a variety of input devices, such as a keyboard and a mouse.

However, with the rapid advancement of an information-oriented society, the usage of computers has gradually been expanded; however, it is difficult to efficiently operate products using only a keyboard and a mouse which currently serve as input devices. Therefore, the necessity for a device, which has a simple configuration and less malfunction and is configured for anyone to easily input information, has increased.

In addition, techniques for input devices have progressed toward techniques related to high reliability, durability, innovation, designing and processing beyond a level of satisfying general functions. To this end, a touch sensor (touch screen) has been developed as an input device capable of inputting information, such as text and graphics, as non-limiting examples.

The touch sensor is a device which is mounted on a display surface of a display such as an electronic organizer, a flat panel display device including a liquid crystal display (LCD) device, a plasma display panel (PDP), and an electroluminescence (El), as non-limiting examples, and a cathode ray tube (CRT) to be used to allow a user to select desired information while viewing the display.

In addition, a type of the touch sensor may be classified into a resistive type, a capacitive type, an electro-magnetic type, a surface acoustic wave (SAW) type, and an infrared type. These various types of touch sensors have been adapted for electronic products in consideration of a signal amplification problem, a resolution difference, a difficulty of designing and processing technology, optical characteristics, electrical characteristics, mechanical characteristics, anti-environment characteristics, input characteristics, durability, and economic efficiency. Currently, the resistive type touch sensor and the capacitive type touch sensor have been used in a wide range of fields.

A window glass provided at an outermost side of a structure of the touch sensor is generally provided with a black bezel part, and a white bezel part, as non-limiting examples, which may cover an electrode wiring or may be formed with a decorative pattern.

Korean Patent Publication No. 2010-0134226

A detailed example of the touch sensor according to the prior art in which the bezel part is formed may include a touch sensor which is disclosed in Korean Patent Laid-Open Publication No. 2010-0134226. However, the touch sensor according to the prior art has a problem in which an electrode is disconnected due to a step or surface non-uniformity due to the bezel part when the electrode is formed in the bezel part.

### SUMMARY

Accordingly, embodiments of the invention have been made to provide a touch sensor with an improved defective rate by previously preventing or reducing a step or surface non-uniformity due to a bezel.

According to at least one embodiment of the invention, there is provided a touch sensor including a first window substrate, a dam formed along an edge of the first window substrate, a polymer layer formed on the first window substrate in an inside direction of the dam, a bezel formed to be disposed outside the dam and formed on the first window substrate, and a second window substrate having one surface formed to face the first window substrate and the other surface provided with an electrode pattern, and provided with an electrode wiring, which is electrically connected to the electrode pattern.

According to at least one embodiment of the invention, the dam is made of an insulating material.

According to at least one embodiment of the invention, the dam is formed to make heights in a thickness direction of the bezel and the polymer layer correspond to each other.

According to at least one embodiment of the invention, the touch sensor further includes an insulating layer formed to apply the electrode pattern and the electrode wiring.

According to at least one embodiment of the invention, the touch sensor further includes a second electrode pattern formed on the insulating layer, and second electrode wirings formed at both ends of the second electrode pattern for electrical connection of the electrode patterns.

According to at least one embodiment of the invention, as a material of the insulating layer, at least one of acryls, urethanes, silicones, polyesters, polyamides, epoxys, vinyl alkyl ethers. SiOx, and SiNx is used.

According to another embodiment of the invention, there is provided a touch sensor including a window substrate; a dam formed along an edge of the window substrate, a polymer layer having one surface formed on the window substrate and the other surface provided with an electrode pattern, and provided with the electrode pattern, and a bezel formed to be disposed outside the dam, formed on the window substrate, and provided with an electrode wiring connected to the electrode pattern, wherein the polymer layer is formed to be disposed inside the dam.

According to at least one embodiment of the invention, the dam is made of an insulating material.

According to at least one embodiment of the invention, the dam is formed to make heights in a thickness direction of the bezel and the polymer layer correspond to each other.

According to at least one embodiment of the invention, the touch sensor further includes an insulating layer formed on the electrode pattern and the electrode wiring.

According to at least one embodiment of the invention, the touch sensor further includes a second electrode pattern formed on the insulating layer, and second electrode wirings formed at both ends of the second electrode pattern for electrical connection of the electrode pattern.

According to at least one embodiment of the invention, the touch sensor further includes as a material of the insulating layer, at least one of acryls, urethanes, silicones, polyesters, polyamides, epoxys, vinyl alkyl ethers. SiOx, and SiNx.

According to still another embodiment of the invention, there is provided a method for manufacturing a touch sensor including the steps of a) preparing a first window substrate, b) forming a dam to protrude along an inner edge of the first window substrate, c) forming a bezel to be disposed outside the dam, d) forming a polymer layer so as to be disposed inside the dam, and e) bonding a second window substrate having one surface formed to face the first window substrate and the other surface provided with an electrode pattern, and provided with an electrode wiring which is electrically connected to the electrode pattern.

According to at least one embodiment of the invention, in the step b), the dam is formed to be higher than a particle of ink forming the bezel when the dam is formed.

According to at least one embodiment of the invention, in the b), the dam is made of a material which does not react when the bezel contacts the polymer layer.

According to at least one embodiment of the invention, in the c), the bezel is formed up to a height in a thickness direction of the dam.

According to at least one embodiment of the invention, in the d), the polymer layer is formed up to a height in a thickness direction of the dam.

According to at least one embodiment of the invention, the method for manufacturing a touch sensor further includes, after the step e), a step e1) forming an insulating layer formed to apply the electrode pattern and the electrode wiring.

According to at least one embodiment of the invention, the method fur manufacturing a touch sensor further includes, after the step e1), a step e2) forming a second electrode pattern formed on the insulating layer, and forming second electrode wirings formed at both ends of the second electrode pattern for electrical connection of the electrode patterns.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of a touch sensor according to at least one embodiment of the invention.

FIG. 2 is a plan view of the touch sensor shown in FIG. 1 according to at least one embodiment of the invention.

FIG. 3 is a cross-sectional view of a touch sensor according to another embodiment of the invention.

FIGS. 4 to 9 illustrate a method for manufacturing a touch sensor according to various embodiments of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiment of the present invention. Like reference numerals refer to like elements throughout the specification.

Hereinafter, various embodiments of the present invention will be described in detail with reference to the accompanying drawings.

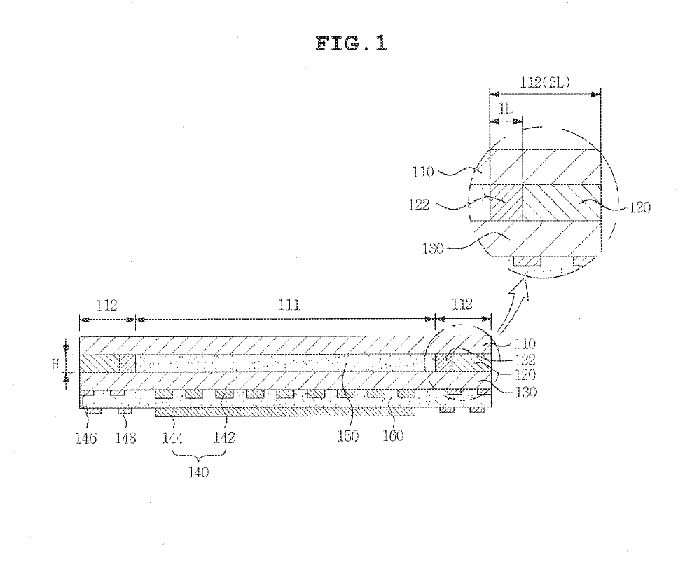

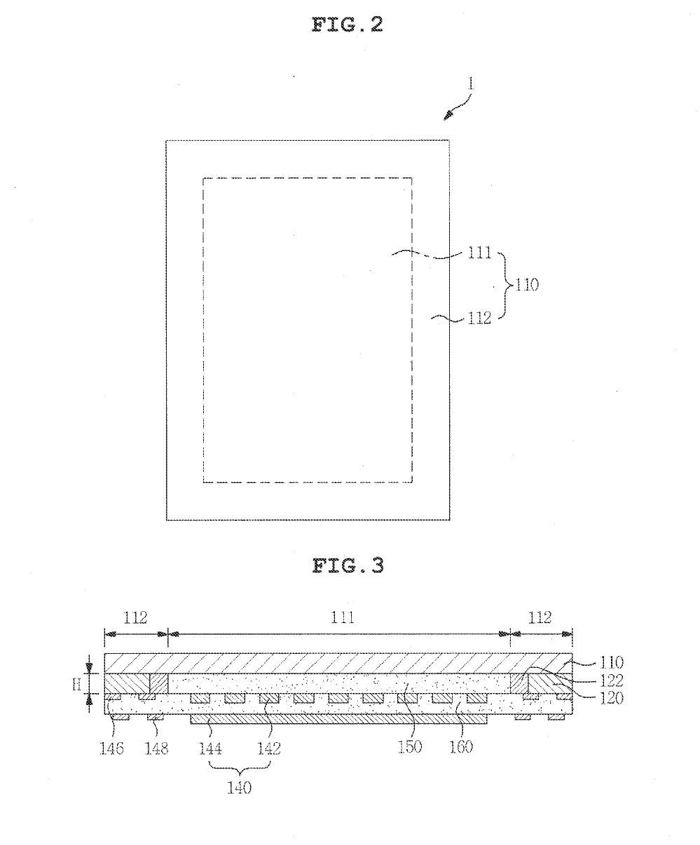

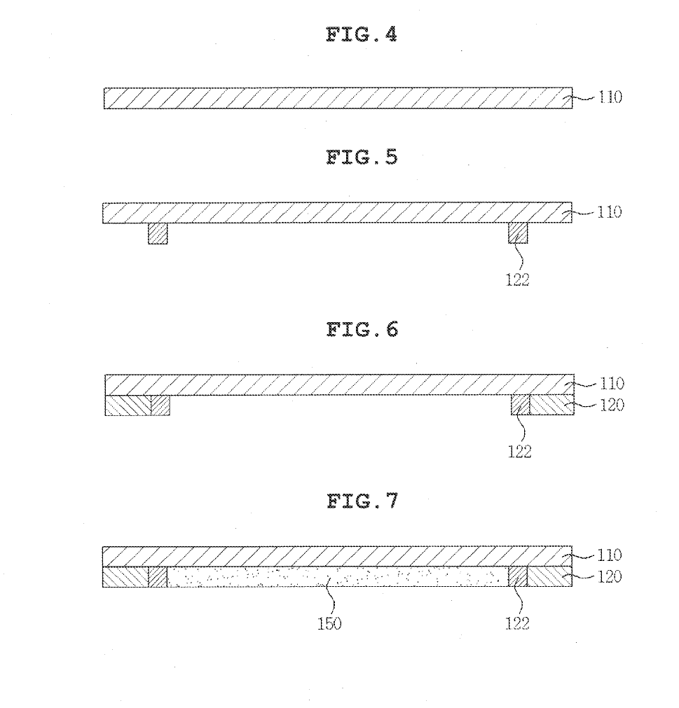

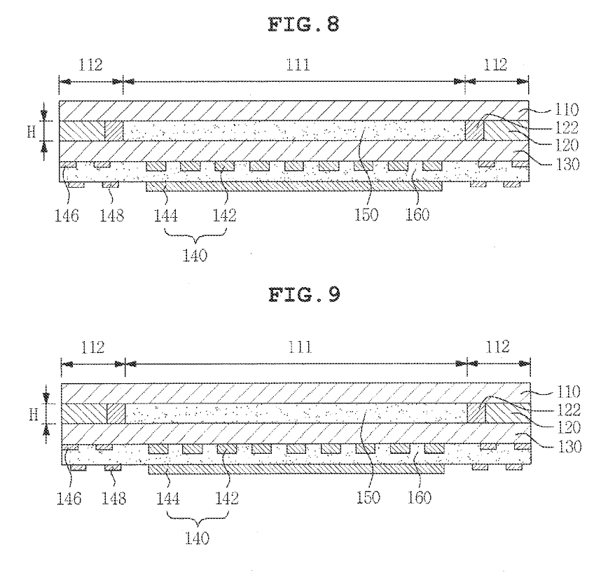

FIG. 1 is a cross-sectional view of a touch sensor according to at least one embodiment of the invention, FIG. 2 is a plan view of the touch sensor shown in FIG. 1 according to at least one embodiment of the invention, FIG. 3 is a cross-sectional view of a touch sensor according to another embodiment of the invention, and FIGS. 4 to 9 illustrate a method for manufacturing a touch sensor according to at least one embodiment of the invention.

Various embodiments of the invention remove or minimize a step, which occurs at the time of machining a window substrate and a bezel, thereby improving electrical operation reliability of an electrode pattern.

Referring to FIG. 1, the touch sensor, according to at least one embodiment of the invention, includes a first window substrate, a dam which is formed along an edge of the first window substrate, a polymer layer which is formed to be filled in the dam and to contact the first window substrate, a bezel which is formed to be disposed outside the dam and formed to contact the first window substrate, and a second window substrate which has one surface facing the first window substrate and the other surface provided with an electrode pattern and is provided with an electrode wiring electrically connected to the electrode pattern.

Referring to FIGS. 1 and 2, the first window substrate 110 is formed at an outermost side in a direction which a user touch is input and uses tempered glass, for example, of a predetermined strength or more to simultaneously serve to a protective layer which protects a touch sensor 1. When considering support force and transparency described above, the first window substrate 110 is made of materials, such as polyethylene terephthalate (PET), polycarbonate (PC), poly methyl methacrmethacrylate (PMMA), polyethylene naphthalate (PEN), polyethersulpon (PES), a cyclic olefin polymer (COC), a triacetylcellulose (TAC) film, a polyvinyl alcohol (PVA) film, a polyimide (PI) film, polystyrene (PS), and biaxially oriented polystyrene (BOPS; containing K resin), in consideration of the transparency.

As illustrated in FIG. 2, the first window substrate 110 is partitioned into an active area 111 and a non-active area 112 formed along an edge of the active area 111. The active area 111 is an area in which a touch action by the user is performed and a screen area in which the user visually confirms an operation scene of a device. Further, the non-active area 112 is an area which is covered by bezels 120 and dams 122 to be described below which are formed on the first window substrate 110 and thus is not exposed to the outside.

According to at least one embodiment, the dam 122 prevents the bezel 120 and the polymer layer 150 to be described below from being mixed with each other. Thus, the dam 122 is formed between the bezel 120 and the polymer layer 150. The dam 122 and the bezel 120 are formed in the non-active area 112. The dam 122 serves to cover one portion of the first electrode wiring 146 or serves as decoration. Like the bezel 120, the dam 122 is formed with a decorative pattern like a logo of a maker, if necessary.

According to at least one embodiment, in consideration of visibility of the touch sensor 1 and a height of a product, a height H of the dam 122 may be properly formed in a range from 0 μm to 40 μm or less. The dam 122 is formed up to a height at which the bezel 120 and the polymer layer 150 are formed. The dam 122 is to make the bezel 120 and the polymer layer 150 be formed as a plane. Further, the dam 122 is formed to keep a plane when being bonded with a second window substrate 130.

According to at least one embodiment, the dam 122 is made of an insulating material and is made of a material, which does not react when the bezel 120 contacts the polymer layer 150. A width L of the dam 122 is formed to have adhesion and rigidity so as not to be inclined when the bezel 120 and the polymer layer 150 are each formed. The width L of the dam 122 is preferably formed so as not to exceed 50% with respect to the width of the non-active area 112. This is not to limit the width of the dam 122. At the time of forming the dam 122, the dam 122 is formed to be higher than a particle of ink forming the bezel 120 and the polymer layer 150. This is to prevent the bezel 122 and the polymer layer 150 from protruding.

According to at least one embodiment, the bezel 120 serves to shield a first electrode wiring 146 transferring an electrical signal of the electrode pattern 140 to be described below to prevent the first electrode wiring 146 from being exposed to the outside. Like the dam 122, the bezel 120 is formed in the non-active area 112. The bezel 120 is formed along an edge of the first window substrate 110 and is disposed outside the dam 122. The bezel 120 is preferably formed to have the same height H as the data 122.

According to at least one embodiment, the bezel 120 serves to cover one portion of the first electrode wiring 146 in the non-active area 112 or serves as decoration. The bezel 122 is formed with a decorative pattern like a logo of a maker, if necessary.

According to at least one embodiment, the polymer layer 150 contacts a portion of the first window substrate 110 and fills between the dams 122. Thus, the polymer layer 150 fills an inner side of the dam 122. The polymer layer 150 is applied up to the height H of the dam 122 to form a horizontal surface. This is to make the height H of the polymer layer 140 and the height H of the bezel 120 he horizontal to each other.

According to at least one embodiment, the polymer layer 150 is formed of an organic insulating layer or an inorganic insulating film, for example, by printing, chemical vapor deposition (CVD), sputtering, spin coating, slot die, a lamination, as non-limiting examples.

In this case, an applying process and a bonding process are performed to make the height H of the polymer layer 150 and the height of the bezel 120 be horizontal to each other.

As a touch sensor 1, according to at least one embodiment of the invention, a resistive type touch sensor, a capacitive type touch sensor, or other various types of touch sensors may be applied and a type and a kind of the touch sensor 1 are not particularly limited. However, in the touch sensor 1 according to at least one embodiment, the capacitive type touch sensor 1 in which electrode patterns 142 and 144 are formed on the second window substrate 130 and the insulating layer, respectively will be described as one example.

According to at least one embodiment, the second window substrate 130 serves to provide an area in which the first electrode pattern 142 for detecting a touched position and the first electrode wiring 146 for transferring the electrical signal are formed. The second window substrate 130 is partitioned into the active area 111 and the non-active area 112, in which the active area 111 is a portion at which the first electrode pattern 42 is formed to recognize a touch of an input means and is provided at a center of the second window substrate 130 and the bezel 120 is a portion at which the first electrode wiring 146 conducted with the first electrode pattern 142 is formed and is provided at the edge of the active area 111. In this case, the second window substrate 130 needs to have support force capable of supporting the first electrode pattern 142 and the electrode wiring 146 and transparency capable of allowing the user to recognize the image provided by an image display device. The second window substrate 130 and the first window substrate 110 is also made of the same material.

According to at least one embodiment, the polymer layer 150 is formed to keep the second window substrate 130 and the first window substrate 110 in a balance state. One surface of the second window substrate 130 is formed to contact the bezel 120, the dam 122, and the polymer layer 150 in a plane.

According to at least one embodiment, the second window substrate 130 needs to have support force capable of supporting the first electrode pattern 142 and transparency to allow a user to recognize images provided from an image display device.

According to at least one embodiment, the second pattern 140 includes the first electrode pattern 142, which is formed on the second window substrate 130 and the second electrode pattern 144, which is formed to be spaced apart from the first electrode pattern 142. An insulating layer 160 is formed between the first electrode pattern 142 and the second electrode pattern 144. The insulating layer 160 serve to dispose the first electrode pattern 142 and the second electrode pattern 144 to face each other. Here, a material of the insulating layer 160 is not particularly limited, but as the material of the insulating layer 160, acryls, urethanes, silicones, polyesters, polyamides, epoxys, vinyl alkyl ethers, SiOx, and SiNx, for example, are used.

In some cases, as a material of the insulating layer 160, an optical clear adhesive (OCA), a double adhesive tape (DAT), other transparent insulating materials is also used.

According to at least one embodiment, the electrode pattern 140 generates a signal by a touch input means to allow a control unit (not illustrated) to serve to recognize touched cooperates. The first electrode pattern 142 and the second electrode pattern 144 is formed in an intersecting direction to each other. For example, when at least one first electrode pattern 142 is formed to be parallel with each other in an X-axis direction, the second electrode pattern 144 is also formed as at least one electrode pattern 140 to be parallel with each other in a axis direction intersecting the first electrode pattern 142. Therefore, coordinates of points touched by the user are recognized by the first electrode pattern 142 and the second electrode pattern 144, and thus the touch sensor is driven.

According to at least one embodiment, as the use material of the first electrode pattern 142 and the second electrode pattern 144, any material having conductivity may be used without being particularly limited. According to at least one embodiment, the first electrode pattern 142 and the second electrode pattern 144 are formed in a mesh pattern using copper (Cu), aluminum (Al), gold (Au), silver (Ag), titanium (Ti), palladium (Pd), chromium (Cr), nickel (Ni) or a combination thereof. In particular, the mesh pattern is formed by continuously arranging at least one unit pattern (not illustrated). Here, the unit pattern selectively has a quadrangular shape, a triangular shape, a diamond shape, and other various shapes.

Meanwhile, the first electrode pattern 142 and the second electrode pattern 144 are also made of metal silver formed by exposing/developing a silver salt emulsion layer, metal oxides, such as an indium thin oxide (ITO), for example, a conductive polymer, such as PEDOT/PSS, for example, having excellent flexibility and a simple coating process is used, in addition the above-mentioned metal.

In some cases, the first electrode pattern 142 and the second electrode pattern 144 are formed on the second window substrate 130. A self-capacitive type touch sensor or a mutual capacitive type touch sensor (not illustrated) is also manufactured using the electrode pattern 140 having a one layer structure.

In a touch sensor according to a second preferred embodiment of the present invention, the description of the structure and the material of the window substrate 110, the dam 122, the bezel 120, the polymer layer 150 which are the same components as the first preferred embodiment of the present invention will be omitted and therefore a structure of an electrode pattern according to the second preferred embodiment of the present invention will be described in detail.

The touch sensor, according to another embodiment of the invention, includes the window substrate 110, the dam 122, which is formed along the edge of the window substrate 110, the bezel 120, which is formed to be disposed outside the dam 122 and is formed to contact the window substrate 110, the polymer layer 150, which has one surface formed to contact the window substrate 110 and the other surface provided with the electrode pattern 140 and is provided with the electrode wiring electrically connected to the electrode pattern 140.

In the touch sensor, according to another embodiment of the invention, the second window substrate 130, which is a component of the first preferred embodiment of the present invention will be omitted. The structure and material of the window substrate 110, the dam 122, the bezel 120, the polymer layer 150, and the electrode pattern 140 will not be described since the repetitive description thereof may unnecessarily obscure the gist of the present invention.

According to at least one embodiment, the dam 122, the bezel 120, and the polymer layer 150 are formed to have the same height. The dam 122, the bezel 120, and the polymer layer 150 are each formed to be bonded to one surface of the window substrate 110. The other surface of the polymer layer 150 is provided with the first electrode pattern 142. The other surface of the dam 122 and the bezel 120 is provided with the first electrode wiring 146, which is connected to the first electrode pattern 142.

Referring to FIGS. 4 to 9, a method for manufacturing a touch sensor 1 includes a) preparing the first window substrate, b) forming the dam along an inner edge of the first window substrate, c) forming the bezel to be disposed outside the dam, d) forming the polymer layer so as to be disposed inside the dam, and c) bonding the second window substrate, which has one surface formed to face the first window substrate and the other surface provided with the electrode pattern and is provided with the electrode wiring, which is electrically connected to the electrode pattern.

FIG. 4 illustrates a process of preparing the first window substrate. The first window substrate 110 is made of a transparent material to increase the visibility of the touch sensor 1 and uses tempered glass to protect the inside thereof from external impact. The material of the first window substrate 110 and the related description thereof are already described in the touch sensor 1 according to the preferred embodiment of the present invention and therefore the overlapping description thereof will be omitted.

FIG. 5 illustrates that the dam is formed on a lower surface of the first window substrate. The dam 122 is formed along the edge of the first window substrate by, for example, printing, chemical vapor deposition (CVD), sputtering, spin coating, and slot die, as non-limiting examples. The clams 122 are formed to be spaced apart from each other at a predetermined distance inwardly from the edge of the first window substrate 110. Thus, the dam 122 is formed in the non-active area 112. In consideration of the visibility, the height H of the dam 122 is preferably formed in a range from 0 μm to 40 μm or less.

According to at least one embodiment, the width L of the dam 122 has a width enough not to be swayed at the time of generating the bezel 120 and the polymer layer 150. Further, the material of the dam 122 uses a material, which insulates the bezel 120 and the polymer layer 150. This is to improve the electrical reliability.

FIG. 6 illustrates that the bezel is formed on the lower surface of the first window substrate. The bezel 120 is formed outside the dam 122. Thus, the bezel 120 fills the remaining portion of the non-active area 112 other than the dam 122. The bezel 120 is formed by, for example, printing, chemical vapor deposition (CVD), sputtering, spin coating, and slot die, as non-limiting examples. The bezel 120 is formed up to the height H of the dam 122.

FIG. 7 illustrates that the polymer layer is formed on the lower surface of the first window substrate. The polymer layer 150 is formed inside the dam 122. Thus, the polymer layer 150 fills the active area 111. The polymer layer 150 is formed by, for example, printing, chemical vapor deposition (CVD), sputtering, spin coating, and slot die, as non-limiting examples. The bezel 120 is formed up to the height H of the dam 120.

FIG. 8 illustrates that the polymer layer and the second window substrate are bonded to each other. One surface of the second window substrate 110 is formed to contact the bezel 120, the dam 122, and the polymer layer 150. In this case, the second window substrate 130 is formed by being pressed to keep the horizontal state.

According to at least one embodiment, the active area 111 of the second window substrate 130 is provided with the first electrode pattern 142. The non-active area 112 of the second window substrate is provided with the first electrode wiring 146, which transfers the electrical signal to the first electrode pattern 142.

FIG. 9 illustrates that the insulating layer is formed on the first electrode pattern and the first electrode wiring. The insulating layer 160 is applied to the first electrode pattern 142 and the first electrode wiring 160. The second electrode pattern 144 and a second electrode wiring 148 are formed on the lower surface of the insulating layer.

According to various embodiments of the invention, it is possible to prevent a mixing of the bezel with the polymer layer, which occurs during the process by forming a dam between a bezel and a polymer layer.

Further, it is possible to improve the electrical reliability of the electrical signal by preventing the mixing of the bezel with the polymer layer by forming the dam between the bezel and the polymer layer.

Further, it is possible to provide the touch sensor with the improved electrical conduction reliability between the electrode pattern and the electrode wiring on the window substrate by forming the dam between the bezel and the polymer layer.

Further, it is possible to easily form the electrode pattern and the electrode wiring on the surface of the window substrate by forming the dam between the bezel and the polymer layer.

Further, it is possible to provide the touch sensor to easily form the electrode on the surface of the polymer layer by forming the dam between the bezel and the polymer layer.

Further, it is possible to provide the touch sensor with the improved electrical conduction between the electrode pattern and the electrode wiring of the polymer layer by forming the dam between the bezel and the polymer layer.

Further, it is possible to provide the touch sensor with the improved reliability of the electrode pattern of the polymer layer by forming the dam between the bezel and the polymer layer.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiment of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a, ” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a first window substrate;
a dam formed along an edge of the first window substrate;
a polymer layer formed on the first window substrate in an inside direction of the dam;
a bezel formed to be disposed outside the dam and formed on the first window substrate; and
a second window substrate having one surface formed to face the first window substrate and the other surface provided with an electrode pattern, and provided with an electrode wiring, which is electrically connected to the electrode pattern.

2. The touch sensor as set forth in claim 1, wherein the dam is made of an insulating material.

3. The touch sensor as set forth in claim 1, wherein the dam is formed to make heights in a thickness direction of the bezel and the polymer layer correspond to each other.

4. The touch sensor as set forth in claim 1, further comprising:
an insulating layer formed to apply the electrode pattern and the electrode wiring.

5. The touch sensor as set forth in claim 4, further comprising:
a second electrode pattern formed on the insulating layer; and
second electrode wirings formed at both ends of the second electrode pattern for electrical connection of the electrode patterns.

6. The touch sensor as set forth in claim 5, wherein as a material of the insulating layer, at least one of acryls, urethanes, silicones, polyesters, polyamides, epoxys, vinyl alkyl ethers, SiOx, and SiNx is used.

7. A touch sensor, comprising:
a window substrate;
a dam formed along an edge of the window substrate;
a polymer layer having one surface formed on the window substrate and the other surface provided with an electrode pattern, and provided with the electrode pattern; and
a bezel formed to be disposed outside the dam, formed on the window substrate, and provided with an electrode wiring connected to the electrode pattern,
wherein the polymer layer is formed to be disposed inside the dam.

8. The touch sensor as set forth in claim 7, wherein the dam is made of an insulating material.

9. The touch sensor as set forth in claim 7, wherein the dam is formed to make heights in a thickness direction of the bezel and the polymer layer correspond to each other.

10. The touch sensor as set forth in claim 7, further comprising:
an insulating layer formed on the electrode pattern and the electrode wiring.

11. The touch sensor as set forth in claim 10, further comprising:
a second electrode pattern formed on the insulating layer; and
second electrode wirings formed at both ends of the second electrode pattern for electrical connection of the electrode pattern.

12. The touch sensor as set forth in claim 11, further comprising:
as a material of the insulating layer, at least one of acryls, urethanes, silicones, polyesters, polyamides, epoxys, vinyl alkyl ethers, SiOx, and SiNx is used.

13. A method for manufacturing a touch sensor, comprising:
a) preparing a first window substrate;
b) forming a dam to protrude along an inner edge of the first window substrate;
c) forming a bezel to be disposed outside the dam;
d) forming a polymer layer so as to be disposed inside the dam; and
e) bonding a second window substrate having one surface formed to face the first window substrate and the other surface provided with an electrode pattern, and provided with an electrode wiring which is electrically connected to the electrode pattern.

14. The method as set forth in claim 13, wherein in the b), the dam is formed to be higher than a particle of ink forming the bezel when the dam is formed.

15. The method as set forth in claim 13, wherein in the b), the dam is made of a material, which does not react when the bezel contacts the polymer layer.

16. The method as set forth in claim 13, wherein in the c), the bezel, is formed up to a height in a thickness direction of the dam.

17. The method as set forth in claim 13, wherein in the d), the polymer layer is formed up to a height in a thickness direction of the dam.

18. The method as set forth in claim 13, further comprising:
after the e), e1) forming an insulating layer formed to apply the electrode pattern and the electrode wiring.

19. The method as set forth in claim 18, further comprising:
after the e1), e2) forming a second electrode pattern formed on the insulating layer; and
forming second electrode wirings formed at both ends of the second electrode pattern for electrical connection of the electrode patterns.
